(19) United States
(12) Patent Application Publication
(10) Pub. No.: US 2011/0013037 A1
(43) Pub. Date: Jan. 20, 2011

(54) Head-Separated Camera Device

(76) Inventors: Hiroyuki Irikura, Ome-shi (JP); Hiroshi Shinozaki, Ome-shi (JP); Masatoshi Ookubo, Iruma-shi (JP); Takashi Tsuda, Ome-shi (JP); Koichi Mitsuo, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/829,965

(22) Filed: Jul. 2, 2010

(30) Foreign Application Priority Data
Jul. 15, 2009 (JP) 2009-167086

(51) Int. Cl. H04N 5/228

(52) U.S. Cl. 348/222.1; 348/E05.031

(57) ABSTRACT

According to one embodiment, a head-separated camera device has an imaging unit, control unit configured to control the imaging unit and a connection unit configured to connect the imaging unit with the control unit, wherein the imaging unit comprises a sensor configured to capture an image, and a transmitter configured to transmit a video signal, a synchronization signal, and a clock signal, for recovering or reproducing the image captured by the sensor, and the control unit comprises detector configured to detect that the imaging unit is connected to the control unit if a preset value preset in the imaging unit is read via a control line, and a setting module configured to set a register setting in the sensor if the detector detects connection of the imaging unit.

### CROSS-REFERENCE TO RELATED APPLICATIONS

This application is based upon and claims the benefit of priority from Japanese Patent Application No. 2009-167086, filed Jul. 15, 2009; the entire contents of which are incorporated herein by reference.

### FIELD

Embodiments described herein relate generally to a head-separated camera device in which an imaging unit and a control unit for controlling the imaging unit are separate from each other.

### BACKGROUND

As is known well, a head-separated camera device is configured such that an imaging unit including a solid-state imaging element, and a control unit, which supplies the solid-state imaging element of the imaging unit with a drive control signal and obtains a video signal by performing a signal processing on an output of the solid-state imaging element, are constituted as separate members. The imaging unit and the control unit are connected through a camera cable which bundles plural signal lines.

In general, head-separated camera devices are developed for the purpose of, for example, inspecting narrow areas where people cannot enter in. Therefore, imaging unit thereof are demanded to be downsized as much as possible. Further, a cable which is used to connect the imaging unit and the control unit to each other is demanded to be long.

If an analog sensor such as a charge coupled device (CCD) sensor is used for the imaging unit, a synchronization signal is output from the imaging unit when the control unit transmits a synchronization signal to the imaging unit. Therefore, the control unit can detect presence or absence of the imaging unit.

If a digital sensor such as a complementary metal-oxide semiconductor (CMOS) sensor is used for the imaging unit, no synchronization signal is output to the imaging unit merely by causing the control unit to transmit a synchronization signal to the imaging unit. In this case, a synchronization signal is output to the control unit only after a control line is connected to the imaging unit by, for example, a microcomputer. In such a head-separated camera device, the control unit transmits a register setting to the imaging unit after the imaging unit detects that the imaging unit is connected to the control unit.

Jpn. Pat. Appln. KOKAI Publication No. 2001-346076 discloses a technique of determining whether a camera head and a CCU are connected to each other or not, based on a signal from the camera head, in a video device in which the camera head and the CCU are connected to each other through a cable.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block configuration diagram for describing a signal processing system of a head-separated camera device according to a first embodiment of the invention;

FIG. 2 is an exemplary block diagram schematically representing the head-separated camera device according to the first embodiment of the invention;

FIG. 3 is an exemplary table representing an example of a setting value written in a recording unit according to the first embodiment of the invention;

FIG. 4 is an exemplary block diagram schematically representing the head-separated camera device according to the first embodiment of the invention;

FIG. 5 is an exemplary block diagram schematically representing another example of the head-separated camera device according to the first embodiment of the invention;

FIG. 6 is an exemplary block diagram schematically representing still another example of the head-separated camera device according to the first embodiment of the invention;

FIG. 7 is an exemplary block diagram schematically representing a head-separated camera device according to a second embodiment of the invention;

FIG. 8 is an exemplary block diagram schematically representing the head-separated camera device according to the second embodiment of the invention;

FIG. 9 is an exemplary block diagram schematically representing a head-separated camera device according to a fourth embodiment of the invention;

FIG. 10 is an exemplary flowchart for describing detection of disconnection of an imaging unit and amplification of an equalizer, according to the fourth embodiment of the invention;

FIG. 11 is an exemplary diagram schematically representing a waveform of serial data according to a fifth embodiment of the invention;

FIG. 12 is an exemplary table representing transmission order data according to the fifth embodiment of the invention;

FIG. 13 is an exemplary block diagram for describing synthesis of a detection signal according to a sixth embodiment of the invention;

FIG. 14 is an exemplary block diagram for describing separation of a detection signal according to the sixth embodiment of the invention; and

FIG. 15 is an exemplary flowchart which combines detection of connection and disconnection of the imaging unit.

### DETAILED DESCRIPTION

Various embodiments will be described hereinafter with reference to the accompanying drawings. In general, according to one embodiment of the invention, a head-separated camera device has an imaging unit, a control unit configured to control the imaging unit, and a connection unit configured to connect the imaging unit with the control unit, wherein the imaging unit comprises a sensor configured to capture an image, and a transmitter configured to transmit a video signal, a synchronization signal, and a clock signal, for recovering or reproducing the image captured by the sensor, and the control unit comprises a receiver configured to receive the video signal, synchronization signal, and clock signal, a video processor configured to perform a video processing with use of the video signal, synchronization signal, and clock signal, a timing signal generator configured to output a drive synchronization signal and a drive clock signal to the sensor, a detector configured to detect that the imaging unit is connected to the control unit if a preset value preset in the imaging unit is read via a control line, and a setting module configured to set a register setting in the sensor if the detector detects connection of the imaging unit.

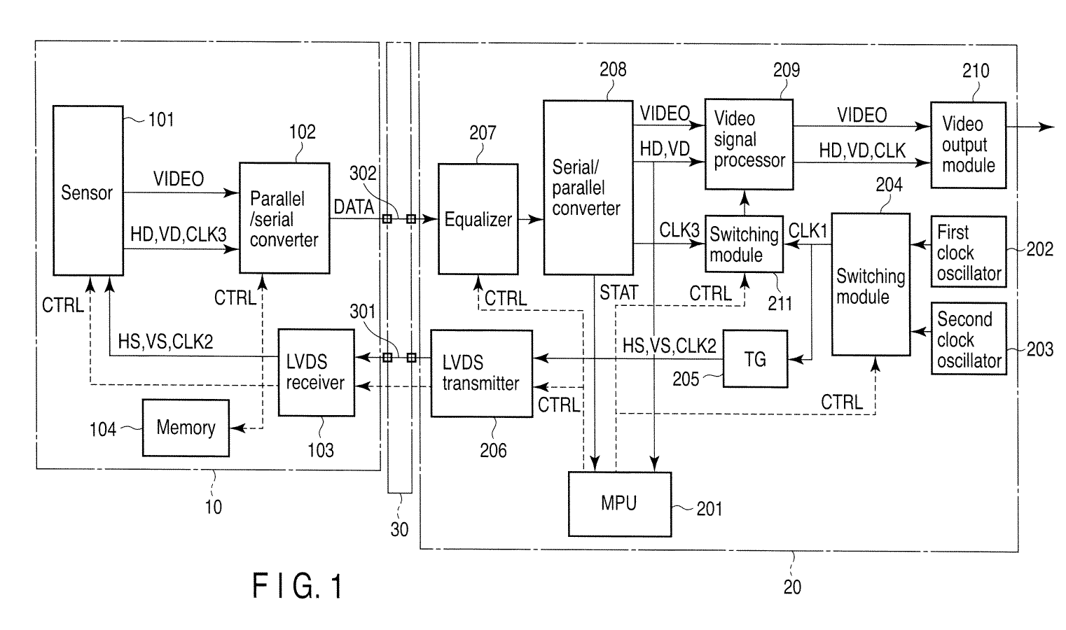

According to an embodiment, FIG. 1 represents a signal processing system of a head-separated camera device according to the first embodiment. Specifically, the head-separated camera device is configured to connect an imaging unit 10 and a control unit 20 by a camera cable 30.

The imaging unit 10 comprises a sensor 101, a parallel/serial converter 102, a low voltage differential signaling (LVDS) receiver 103, and a memory 104. The control unit 20 comprises a micro processing unit (MPU) 201, a first clock oscilator 202, a second clock oscilator 203, a switching module 204, a timing generator (TG: timing signal generator) 205, a LVDS transmitter 206, an equalizer 207, a serial/parallel converter 208, a video signal processor 209, a video output module 210, and a switching module 211. The MPU 201 receives operation information externally supplied from a user, and controls the imaging unit 10 and respective units constituting the control unit 20 so as to reflect the operation information. Broken lines in FIG. 1 express three-line-serial-type control (CTRL) lines of the MPU 201.

Operation of respective units will now be described along signal flow. At first, the first clock oscilator 202 oscillates a clock signal having a predetermined pulse characteristic. The second clock oscilator 203 oscillates a clock signal having a different pulse characteristic from that of the pulse characteristic of the first clock oscillator 202. Under control of the MPU 201, the switching module 204 supplies the TG 205 with a first clock signal (CLK1), by switching a clock signal oscillated by the first clock oscilator 202 and a clock signal oscillated by the second clock oscilator 203 from each other, as the CLK1.

The TG 205 generates a drive control timing for the sensor 101 on the basis of the CLK1. The TG 205 generates a horizontal synchronization signal (HS), a vertical synchronization signal (VS), and a second clock signal (CLK2) for driving the sensor 101. Although the TG 205 is provided in the control unit 20 in view of downsizing of the imaging unit 10, the TG 205 may be provided in the imaging unit 10.

Under control of the MPU 201, the LVDS transmitter 206 supplies the LVDS receiver 102 of the imaging unit 10 with the HS, VS, and CLK2 through a control signal cable 301. Although the LVDS transmitter 206 and LVDS receiver 102 are used to transfer the HS, VS, and CLK2 at a high speed, any other interface may be used instead.

Under control of the MPU 201, the LVDS receiver 102 supplies the sensor 101 with the HS, VS, and CLK2. The sensor 101 includes, for example, a digital sensor such as a CMOS sensor. Based on the HS, VS, and CLK2, the sensor 101 converts an optical image formed on a light receiving surface of the sensor 101 into a corresponding video signal (image signal) (VIDEO), a horizontal video synchronization signal (HD), and a third clock signal (CLK3), and supplies the signals. The VIDEO, HD, and VD are sensor output signals.

Under control of the MPU 201, the parallel/serial converter 103 mixes and converts the VIDEO, HD, VD, and CLK3 into superimposed serial data. The parallel/serial converter 103 simultaneously transmits the CLK3 and the sensor output signals, with the sensor output signals embedded in the CLK3. The parallel/serial converter 103 supplies the equalizer 207 of the control unit 20 with the serial data through the data signal cable 302. The parallel/serial converter 103 also functions as a transmission module. Under control of the MPU 201, the equalizer 207 amplifies the serial data. In this embodiment, a serializer as the parallel/serial conversion unit 103, a deserializer as the serial/parallel conversion unit 208, and the equalizer 207 in a front side of the deserializer are provided. However, the equalizer 207 may be unused. Communication between the imaging unit 10 and the control unit 20 may be performed through either a serial control line or a parallel control line. Any of differential transfer, parallel/serial communication, and optical transfer may be employed for transfer between the imaging unit 10 and the control unit 20.

The serial/parallel converter 208 separates the serial data amplified by the equalizer 207 into parallel data consisting of VIDEO, HD, VD, and CLK3. The serial/parallel converter 208 also functions as a receiving module. The serial/parallel converter 208 supplies the video signal processing unit 209 with the VIDEO, HD, and VD. The serial/parallel converter 208 supplies the switching module 211 with the CLK3. Under control of the MPU 201, the switching module 211 supplies the video signal processor 209 with the CLK1 or CLK3, switching adequately the CLK1 and the CLK3 from each other. In this embodiment, the signal supplied to the video signal processor 209 is referred to as CLK.

The video signal processor 209 performs a preset predetermined signal processing on the VIDEO, HD, VD, and CLK. The video signal processor 209 supplies the video output module 210 with the VIDEO, HD, VD, and CLK subjected to the signal processing. The video output module 210 converts the VIDEO, HD, VD, and CLK into a video signal according to a predetermined standard, and outputs an image to an unillustrated monitor.

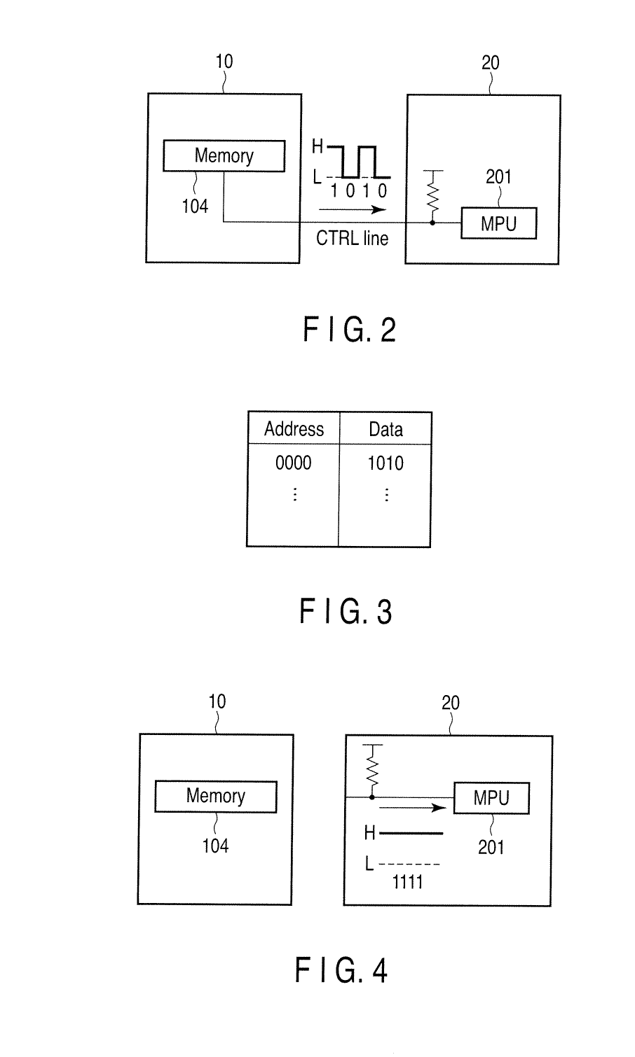

Described next will be detection of connection of the imaging unit 10 according to the first embodiment. FIG. 2 is a block diagram schematically representing a head-separated camera device represented in FIG. 1. The memory 104 is, for example, an electrically erasable programmable read-only memory (EEPROM). The CTRL line connecting the MPU 201 to the memory 104 is pulled up in the side of the control unit 20.

Predetermined setting values have been written in the memory 104. FIG. 3 represents an example of setting values written in the memory 104. The memory 104 records data of 1010 at an address 0000.

If the imaging unit 10 is connected to the control unit 20, the MPU 201 reads data of 1010 from the memory 104, as represented in FIG. 2. If the MPU 201 reads the data of 1010 as an expected value, the imaging unit 10 detects that the imaging unit 10 is connected to the control unit 20.

FIG. 4 is a block diagram schematically representing a state in which the imaging unit 10 is not connected to the control unit 20. Since the MPU 201 cannot read data from the memory 104, the MPU 201 reads data of 1111 instead. This is because the CTRL line is pulled up. That is, if the MPU 201 is not connected to any destination, the MPU 201 always reads a signal level of the CTRL line as a level H. Therefore, if the MPU 201 reads data of 1111 which differs from an expected value, the MPU 201 then detects that the imaging unit 10 is not connected to the control unit 20. According to the first embodiment, presence or absence of connection to the imaging unit 10 can be easily detected without adding any special configuration.

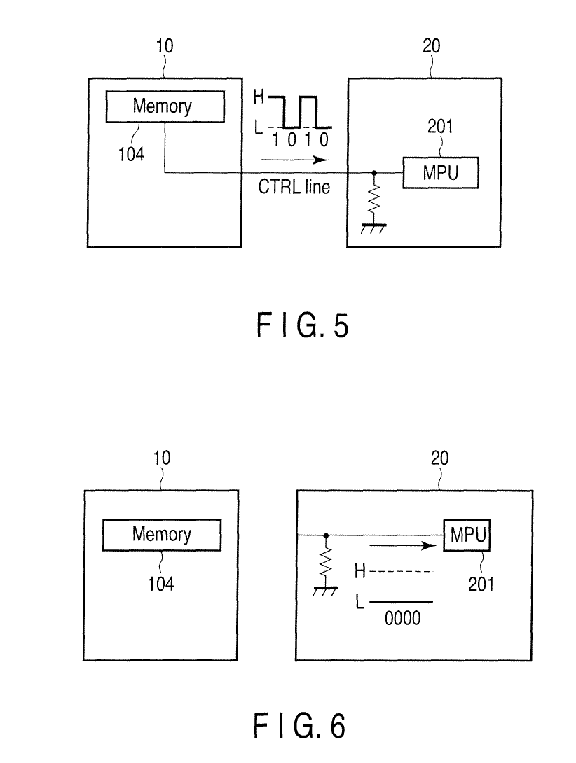

Next, another example of the first embodiment will be described. FIG. 5 is a block diagram schematically representing the head-separated camera device represented in FIG. 1. The CTRL line connecting the MPU 201 to the memory 104 is pulled down in the side of the control unit 20. If the imaging unit 10 is connected to the control unit 20, the MPU 201 reads data of 1010 from the memory 104, as represented in FIG. 5. If the MPU 201 reads data of 1010 which is an expected value, the MPU 201 detects that the imaging unit 10 is connected to the control unit 20.

FIG. 6 is a block diagram schematically representing a state in which the imaging unit 10 is not connected to the control unit 20. The MPU 201 cannot read data from the memory 104, and therefore reads data of 0000 instead. This is because the CTRL line is pulled down. Specifically, if the CTRL line is not connected to any destination, the MPU 201 always reads the signal level of the CTRL line as a level L. Therefore, if the MPU 201 reads data of 0000 different from an expected value, the imaging unit 10 detects that the imaging unit 10 is not connected to the control unit 20.

If a period of the level H continues longer than that of the level L in data flowing through the CTRL line in a state that the imaging unit 10 is connected to the control unit 20, power consumption is smaller when the CTRL line is pulled up than when the CTRL line is pulled down.

Otherwise, if a period of the level L continues longer than that of the level H in data flowing through the CTRL line in a state that the imaging unit 10 is connected to the control unit 20, power consumption is smaller when the CTRL line is pulled down than when the CTRL line is pulled up.

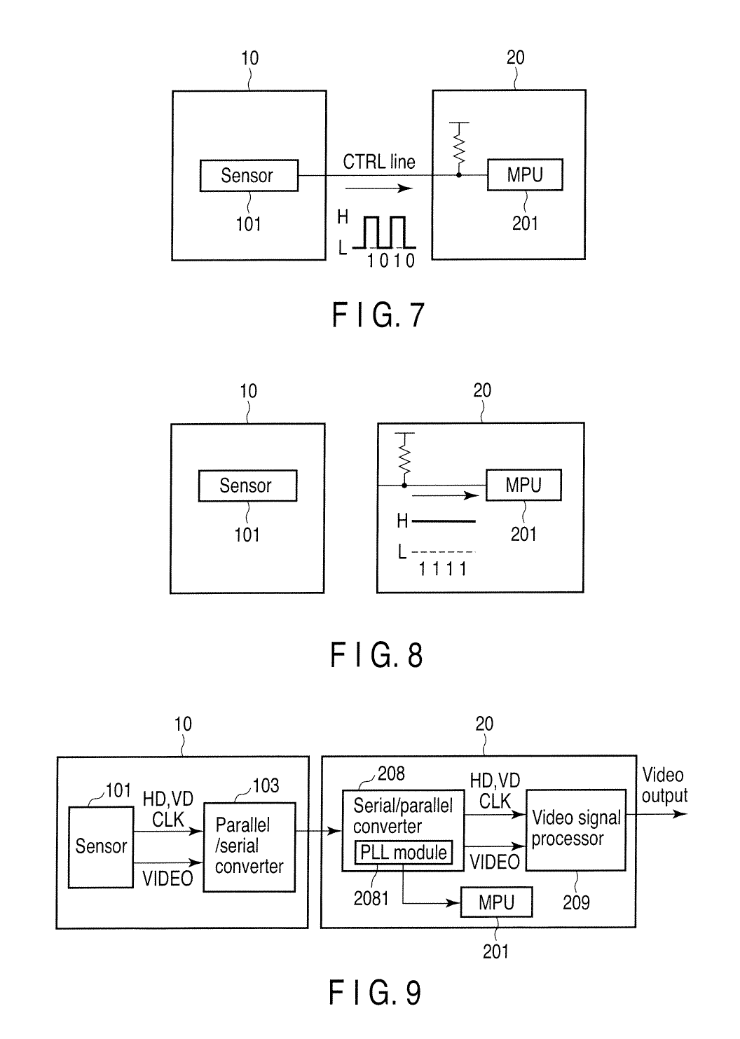

Described next will be detection of connection of the imaging unit 10 according to the second embodiment. A head-separated camera device according to the second embodiment has the same configuration as in FIG. 1. FIG. 7 is a block diagram schematically representing the head-separated camera device represented in FIG. 1. The MPU 201 reads a register of the sensor 101. For example, a version value is set in the register. As the version value, for example, 1010 is set.

If the imaging unit 10 is connected to the control unit 20, the MPU 201 reads data of 1010 from a sensor 101. When the MPU 201 reads the data of 1010 which is an expected value, the MPU 201 then detects that the imaging unit 10 is connected to the control unit 20.

FIG. 8 is a block diagram schematically representing a state in which the imaging unit 10 is not connected to the control unit 20. The MPU 201 cannot read a version value from a register of the sensor 101 and therefore reads data of 1111 instead. This is because of the same reason as described in the first embodiment. Therefore, if the MPU 201 reads the data of 1111, the MPU 201 then detects that the imaging unit 10 is not connected to the control unit 20. According to the second embodiment, presence or absence of connection of the imaging unit 10 can be easily detected without adding any special configuration. In the second embodiment, the CTRL line is pulled up in the side of the control unit 20. However, the CTRL line may alternatively be pulled down in the side of the control unit 20, as has been described in the first embodiment.

Described next will be detection of disconnection of the imaging unit 10 according to the third embodiment. A head-separated camera device according to the third embodiment has the same configuration as in FIG. 1.

The MPU 201 continually detects the HD, VD, and CLK which are output from the serial/parallel converter 208. While the HD, VD, and CLK are detected to be present, the MPU 201 detects that connection between the imaging unit 10 and the control unit 20 is maintained. The MPU 201 may detect any one of the HD, VD, and CLK. If the MPU 201 detects neither the HD, VD, nor CLK, the MPU 201 detects that the imaging unit 10 and the control unit 20 are disconnected from each other, or that abnormality such as a mulfunction has occurred. According to the third embodiment, disconnection or abnormality of the imaging unit 10 can be easily detected without adding any special configuration.

The third embodiment can be applied to detection of connection of the imaging unit 10. At first, the TG 205 supplies the HS, VS, and CLK to the imaging unit 10. Next, the MPU 201 transmits a register setting to the sensor 101 by the CTRL line. Thereafter, if the MPU 201 detects the HD, VD, or CLK. If the MPU 201 can detect neither the HD, VD, nor CLK, the MPU 201 detects that the imaging unit 10 is not connected to the control unit 20. According to the third embodiment, presence or absence of connection of the imaging unit 10 can be easily detected without adding any special configuration.

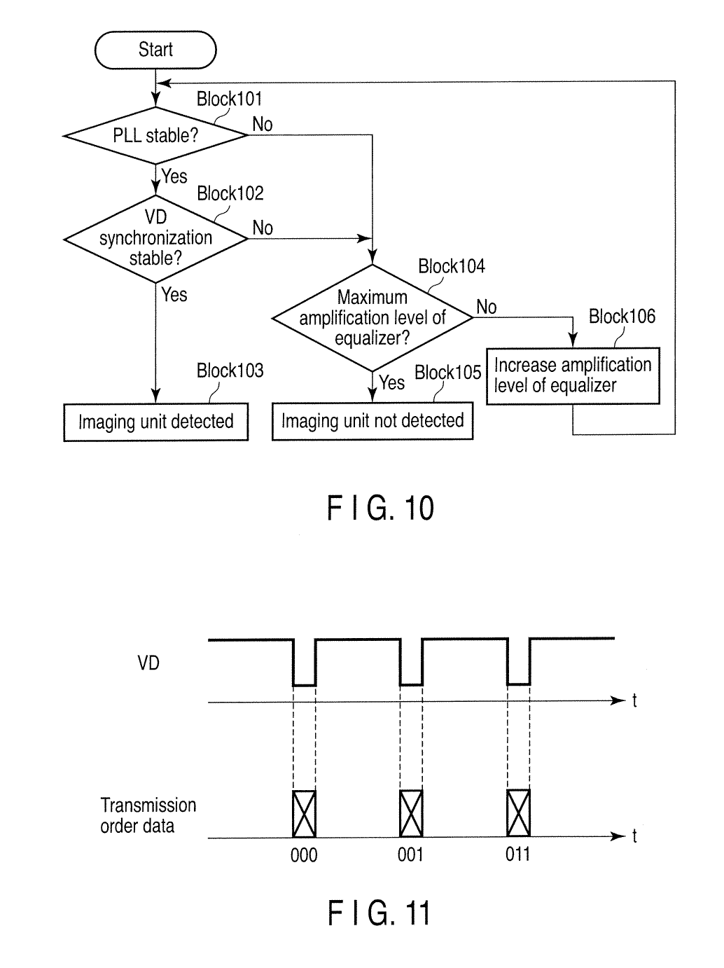

Described next will be detection of connection of the imaging unit 10 according to the fourth embodiment. A head-separated camera device according to the third embodiment has the same configuration as in FIG. 1. FIG. 9 is a block diagram schematically representing the head-separated camera device represented in FIG. 1. The parallel/serial converter 103 superimposes VIDEO, HD, VD, and CLK and supplies the superimposed signals to the serial/parallel converter 208. The serial/parallel converter 208 is provided with a phase-locked loop (PLL) module 2081. The PLL module 2081 properly synchronizes the VIDEO, HD, VD, and CLK.

If the PLL is locked, the serial/parallel converter 208 can properly synchronize the VIDEO, HD, VD, and CLK, and can therefore properly recover signals. The serial/parallel converter 208 transmits, to the MPU 201, information indicating that the PLL is locked. While the PLL is detected to be locked, the MPU 201 detects that connection between the imaging unit 10 and the control unit 20 is maintained. If the PLL is not detected to be locked, the MPU 201 detects that the imaging unit 10 and the control unit 20 are disconnected from each other or that abnormality such as a mulfunction occurs in the imaging unit 10. According to the fourth embodiment, disconnection or abnormality of the imaging unit 10 can be easily detected.

The fourth embodiment can be used for detection of connection of the imaging unit 10. At first, the TG 205 supplies the imaging unit 10 with the HS, VS, and CLK. Next, the MPU 201 transmits a register setting to the sensor 101 by the CTRL line. Thereafter, if the PLL is detected to be locked, by the serial/parallel converter 208, the MPU 201 detects that the imaging unit 10 is connected to the control unit 20. If the PLL is not detected to be locked, by the serial/parallel converter 208, the MPU 201 detects that the imaging unit 10 is not connected to the control unit 20. According to the fourth embodiment, presence or absence of connection of the imaging unit 10 can be easily detected without adding any special configuration. In this case, the MPU 201 has detected a locked PLL of the serial/parallel converter 208. However, this is not a limited case. A PLL circuit may be provided in a video signal processor 209, and the MPU 201 may detect a locked PLL.

Next, control of an equalizer 207 will be described as an application example of the fourth embodiment. FIG. 10 is a flowchart for describing detection of disconnection of the imaging unit 10 and amplication of the equalizer 207. At first, the MPU 201 determines whether or not a PLL is locked to be stable, by the serial/parallel converter 208 (block 101). If the PLL is stable (block 101, YES), the MPU 201 determines whether synchronization of the VD is stable or not (block 102). If synchronization of the VD is stable (block 102, YES), the MPU 201 detects that connection between the imaging unit 10 and the control unit 20 is maintained (block 103). That is, the MPU 201 has detected the imaging unit 10.

If the PLL is not stable (block 101, NO) or if synchronization of the VD is not stable (block 102, NO), the MPU 201 determines whether an amplication level of the equalizer 207 is maximum or not (block 104). If the amplication level of the equalizer 207 is maximum (block 104, YES), the MPU 201 detects that the imaging unit 10 and the control unit 20 have been disconnected from each other (block 103). That is, the MPU 201 has not yet detected the imaging unit 10. If the amplication level of the equalizer 207 is not maximum (block 104, NO), the MPU 201 raises the amplication level of the equalizer 207 and returns to the block 101.

Even when the serial/parallel converter 208 generates an error due to attenuation of serial data supplied from the imaging unit 10, the MPU 201 can detect the error and easily adjust the amplication level of the equalizer 207. Therefore, a video is not interrupted halfway. Accordingly, even if a data signal cable 302 is long or is less reliable, the head-separated camera device can stably transfer serial data.

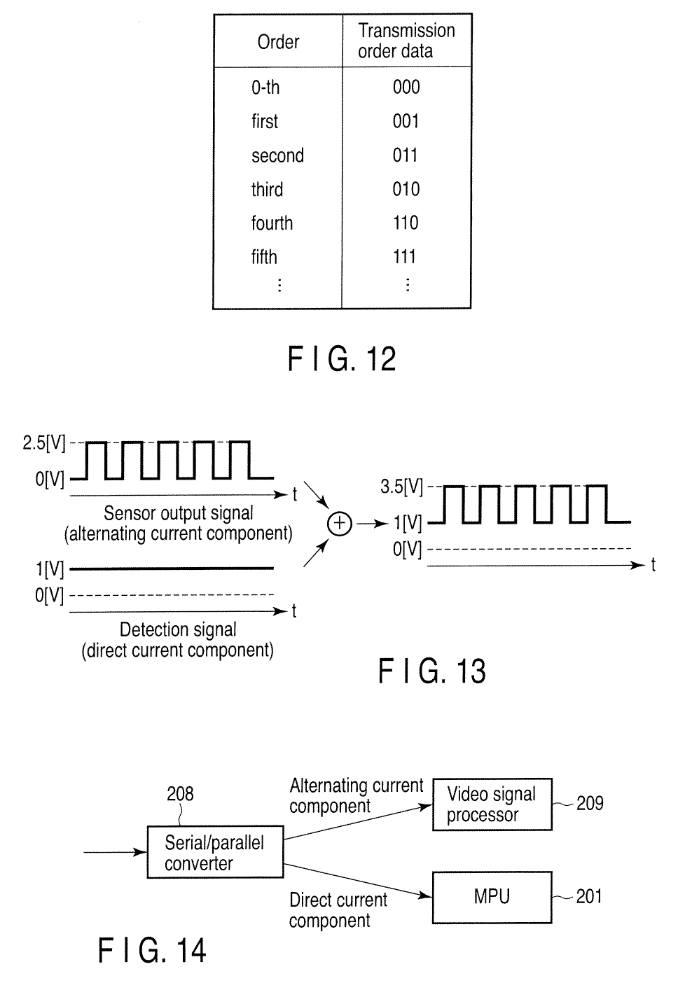

Described next will be detection of connection of the imaging unit 10 according to the fifth embodiment. A head-separated camera device according to the fifth embodiment has the same configuration as in FIG. 1. FIG. 11 schematically represents a waveform of serial data transmitted by a parallel/serial converter 103. FIG. 11 represents a waveform of the VD and a waveform of transmission order data which is inserted in blanking periods of the VD. The transmission order data is, for example, inserted for each blanking period of the VD on a video signal line. FIG. 12 is a table representing relationships between places in the order and data contents. The parallel/serial converter 103 inserts, in blanking periods, data contents which differ depending on the order of transmission order data.

For example, by means of gray codes as follows, the MPU 201 detects whether or not the transmission order data is transmitted in correct order as represented in FIG. 12. If the MPU 201 detects that transmission order data 011 has been transmitted next to transmission order data 001, the MPU 201 detects that second data has been transmitted next to first data. Accordingly, the MPU 201 detects that connection between the imaging unit 10 and the control unit 20 is maintained.

If the MPU 201 detects that transmission order data 010 has been transmitted next to transmission order data 001, the MPU 201 detects that third data has been transmitted next to first data. Therefore, if the transmission order data varies by one bit, the MPU 201 detects that the imaging unit 10 and the control unit 20 are detected to be disconnected from each other or that abnormality such as a mulfunction has occurred in the imaging unit 10.

The MPU 201 transmits, to the serial/parallel converter 208, information indicating whether or not transmission order data is transmitted in a proper order. If the imaging unit 10 and the control unit 20 are detected to be disconnected from each other, the serial/parallel converter 208 continues transmitting the same transmission order data to the MPU 201. According to the fifth embodiment, disconnection or abnormality of the imaging unit 10 can be easily detected without adding any special configuration.

Described next will be detection of connection of the imaging unit 10 according to the sixth embodiment. A head-separated camera device according to the sixth embodiment has the same configuration as in FIG. 1. FIG. 13 is a diagram for describing synthesis of a detection signal of the parallel/serial converter 103. FIG. 14 is a block diagram for describing separation of the detection signal of the serial/parallel converter 208.

As in FIG. 13, the parallel/serial converter 103 adds a detection signal as a direct current component of 1 V to a serialized sensor output signal as an alternating current component. The parallel/serial converter 103 supplies the control unit 10 with the added signals as serial data.

As represented in FIG. 14, the serial/parallel converter 208 separates the serial data supplied from the parallel/serial converter 103, into a direct current component and an alternating current component. The serial/parallel converter 208 separates serial data as the separated alternating current component into parallel data consisting of VIDEO, HD, VD, and CLK3, and supplies the parallel data to the video signal processor 209.

Further, the serial/parallel converter 208 supplies the MPU 201 with a detection signal as the separated direct current component. If the MPU 201 detects a direct current component (1 V), the MPU 201 detects that connection between the imaging unit 10 and the control unit 20 is maintained. If the MPU 201 does not detect the direct current component (but detects 0 V), the MPU 201 detects that the imaging unit 10 and the control unit 20 are disconnected from each other or that abnormality such as a mulfunction occurs in the imaging unit 10. According to the sixth embodiment, disconnection or abnormality of the imaging unit 10 can be easily detected without adding any special configuration.

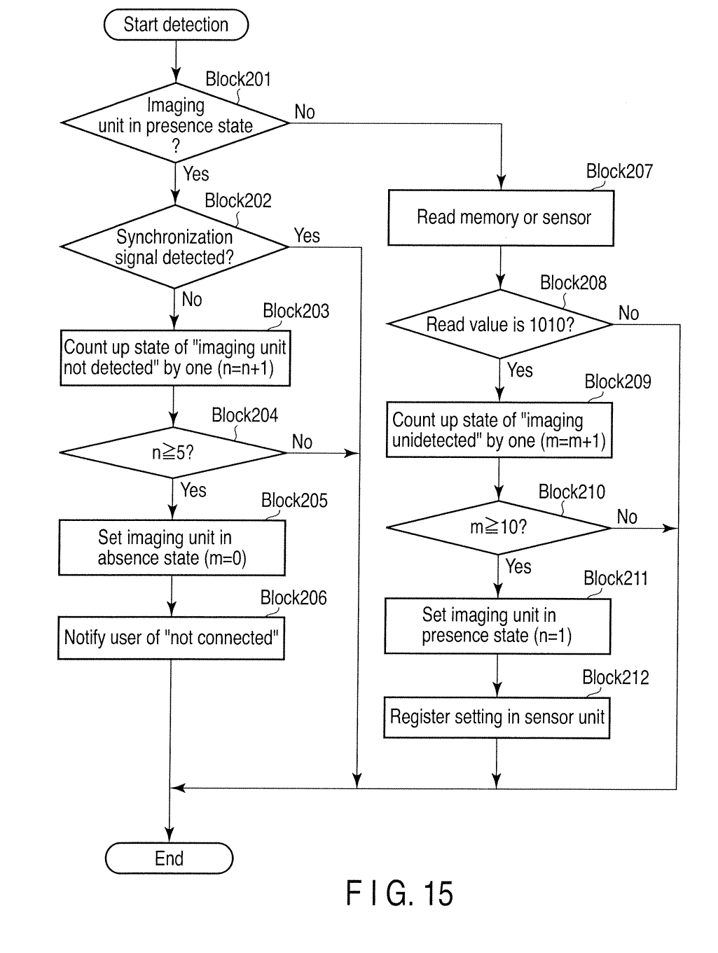

Further, the control unit 20 can efficiently detect connection and disconnection of the imaging unit 10 by combining the first to sixth embodiments in a complex manner. FIG. 15 is a flowchart in which detection of connection of the imaging unit 10 according to the first or second embodiment is combined with detection of disconnection of the imaging unit 10 according to the third embodiment.

At first, the MPU 201 determines a state of the imaging unit 10 (block 201). As states of the imaging unit 10, there are a presence state in which the imaging unit 10 is connected to the control unit 20 and an absence state in which the imaging unit 10 is disconnected from the control unit 20. If the imaging unit 10 is in the presence state (block 201, YES), the MPU 201 outputs the HD, VD, or CLK which is output from the serial/parallel converter 208 (block 202). If the MPU 201 detects the HD, VD, or CLK (block 202, YES), the MPU 201 detects connection between the imaging unit 10 and the control unit 20 to be properly maintained, and terminates detection of the imaging unit 10.

If the MPU 201 cannot detect one of the HD, VD, and CLK (block 202, NO), the MPU 201 counts up a state of “the imaging unit 10 not-detected” (n=n+1) by one (block 203). The MPU 201 detects the disconnected state of the imaging unit 10, depending on a count value n. The MPU 201 determines whether or not n is 5 or more (block 204). If n is not 5 or more (block 204, NO), the MPU 201 terminates detection of the imaging unit 10.

If n is 5 or more (block 204, YES), the MPU 201 detects that the imaging unit 10 and the control unit 20 are disconnected from each other. The MPU 201 changes the state of the imaging unit 10 from the presence state and sets the absence state (block 205). The MPU 201 sets a count value m for detecting the presence state of the image to 0. The MPU 201 displays, for example, information indicating the imaging unit 10 in the presence state (information indicating that the imaging unit 10 enters into a state of being disconnected from the control unit 20, e.g., the data signal cable 302 is detached), on a monitor (block 206). Further, the MPU 201 terminates detection of the imaging unit 10.

If the imaging unit 10 is in the absence state (block 201, NO), the MPU 201 reads a setting value from the memory 104 or the register of the sensor unit 101 (block 207). The MPU 201 determines whether the read value is an expected value (1010 in this case) or not (block 208). If the read value is not 1010 (block 208, NO), the MPU 201 leaves the imaging unit 10 in the absence state and terminates detection of the imaging unit 10. The MPU 201 may display, for example, information indicating that the imaging unit 10 is still in the absence state, on the monitor.

If the read value is 1010 (block 208, YES), the MPU 201 counts up a state of “imaging unit 10 detected” (n=m+1) by one (block 209). The MPU 201 determines whether or not m is 10 or more (block 210). If m is not 10 or more (block 210, NO), the MPU 201 terminates detection of the imaging unit 10. If m is 10 or more (block 210, YES), the MPU 201 changes the state of the imaging unit 10 form the absence state and sets the presence state (block 211). The MPU 201 sets the count value n to 0. For example, the MPU 201 may display, on the monitor, information indicating that the imaging unit 10 has been changed from the absence state to the presence state. Next, the MPU 201 performs a setting of the register of the sensor 101 (block 212). Further, the MPU 201 terminates detection of the imaging unit 10.

As has been described previously, the MPU 201 sets a change of the state of the imaging unit 10 from the presence state to the absence state when the state of “imaging unit 10 not detected” is counted up plural times. This also applies to the state of “imaging unit 10 detected” in a change of the state of the imaging unit 10 from the absence state to the presence state. Therefore, chattering caused by connection/disconnection of the data signal cable 302 can be prevented. Lower limit values for use in the blocks 204 and 210 can be changed arbitrarily.

According to the first to sixth embodiments, states of the head-separated camera device during an activated period, such as a failure in control of the imaging unit 10, disconnection between the imaging unit 10 and the control unit 20, and cut-off of the data signal cable 302, can be detected in addition to an initial state depending on whether the imaging unit 10 is connected to the control unit 20 or not. If a trouble occurs in any part of the head-separated camera device, the user can know accurately a state of the imaging unit 10. Even if connection between the imaging unit 10 and the control unit 20 breaks down, the user can output an image on the monitor by simply connecting the imaging unit 10 to the control unit 20 without turning off the power supply of the head-separated camera device. Further, after turning on the power supply of the head-separated camera device, the control unit 20 and the imaging unit 10 can be connected to each other by the data signal cable 301.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A head-separated camera device comprising an imaging unit, a control unit configured to control the imaging unit, and a connection unit configured to connect the imaging unit with the control unit, wherein
the imaging unit comprises
a sensor configured to capture an image, and
a transmitter configured to transmit a video signal, a synchronization signal, and a clock signal, for recovering or reproducing the image captured by the sensor, and
the control unit comprises
a receiver configured to receive the video signal, synchronization signal, and clock signal,
a video processor configured to perform a video processing with use of the video signal, synchronization signal, and clock signal,
a timing signal generator configured to output a drive synchronization signal and a drive clock signal to the sensor,
a detector configured to detect that the imaging unit is connected to the control unit if a preset value preset in the imaging unit is read via a control line, and
a setting module configured to set a register setting in the sensor if the detector detects connection of the imaging unit.

2. The device of claim 1, wherein the control unit comprises a pull up resister, one side of the pull up resister being connected to the control line, the other side of the pull up resister being connected to a power supply, and if the imaging unit is disconnected from the control unit, the detector is configured to read a value different from the preset value based on a voltage level of the control line.

3. The device of claim 1, wherein the control unit comprises a pull down resister, one side of the pull down resister being connected to the control line, the other side of the pull down resister being connected to ground, and if the imaging unit is disconnected from the control unit, the detector is configured to read a value different from the preset value based on a voltage level of the control line.

4. The device of claim 1, wherein the imaging unit comprises a memory for storing the preset value, and the detector is configured to detect that the imaging unit is connected to the control unit if the detector reads the preset value stored in the memory.

5. The device of claim 1, wherein the sensor is configured to record the preset value as register value and the detector is configured to detect that the imaging unit is connected to the control unit if the detector reads the preset value.

6. The device of claim 1, wherein if the detector fails to detect at least one of the video signal, the synchronization signal, and the clock signal to be received by the receiver, the detector is configured to detect disconnection between the imaging unit and the control unit.

7. The device of claim 1, wherein if the detector detects that the video signal, the synchronization signal, and the clock signal are not synchronized at the receiver, the detector is configured to detect disconnection between the imaging unit and the control unit.

8. The device of claim 7, wherein the control unit comprises an equalizer configured to amplify the video signal, the synchronization signal, and the clock signal if the detector detects that the video signal, the synchronization signal, and the clock signal are not synchronized with each other,

9. The device of claim 1, wherein the transmitter is configured to superimpose data indicating an order of blanking periods of the synchronization signal on the video signal for each blanking period of the synchronization signal and the detector is configured to detect disconnection between the imaging unit and the control unit if the detector detects the data disagrees with the order.

10. The device of claim 1, wherein
the transmitter is configured to transmit the video signal, the synchronization signal, and the clock signal with a detection signal for detecting a direct current component added to the video signal, the synchronization signal, and the clock signal,
the receiver is configured to separate the detection signal from the video signal, the synchronization signal, and the clock signal, and
the detector is configured to detect disconnection between the imaging unit and the control unit if the detection signal cannot be detected.
